(19) United States
(12) Patent Application Publication
(10) Pub. No.: US 2004/0073576 A1
(43) Pub. Date: Apr. 15, 2004

(54) Method for maintaining and managing a manufacturing facility

(76) Inventors: Klaus-Peter Lindner, Steinen (DE); Michael Herzog, Rothenfluh (CH)

Correspondence Address: Felix J D'Ambrosio, Jones Tullar & Cooper, Eads Station, PO Box 2266, Arlington, VA, 22202, US

(21) Appl. No.: 10/466,329

(22) PCT Filed: Jan. 30, 2002
(86) PCT No.: PCT/EP02/00944

(30) Foreign Application Priority Data
Jan. 30, 2001 (DE) 101 04 161.6
Jan. 10, 2002 (DE) 102 01 021.8

(51) Int. Cl. G06F 17/00

(52) U.S. Cl. 707/104.1

(57) ABSTRACT

The invention relates to a method for maintaining and managing a manufacturing facility with a plurality of field devices (F) that are connected to a guide system (L) via a data bus (D). The inventive method is characterized in that information of at least the field devices that are required for the maintenance and management of the manufacturing facility are electronically acquired across the entire life cycle of the respective field device and are stored via intranet or internet access in a central data bank that is accessible for selected users. The user inquires the maintenance or management criteria via intranet or internet access to the central data bank (Z). In this manner, all information required for the maintenance and management of the manufacturing facility are made available to selected users in a simple way.

The invention relates to a method for maintaining and managing a manufacturing facility, as defined in the preamble of claim 1.

In automation and process control technology, it is common to apply field devices that determine or influence a process variable as the process runs.

Field devices for determining flow, fill level, difference pressure, temperature, etc., are generally known. They serve to register the corresponding process variables mass- or volume-flow, fill height, pressure, temperature, etc.

The field devices each produce measurement signals, which are a measure for the registered process variable. As a rule, the field devices are in part, or all, connected to a control room or a guide, or supervisory control and data acquisition (SCADA), system. The measurement signals are transferred to the control room or the guide system.

Usually, the entire process control is done from the control room or from the guide system, where the different measurement signals of the various field devices are evaluated and control signals are produced on the basis of the evaluation for the field devices (actors), for instance valves, which control the course of the process.

Signal transmission between field devices and control room or guide system proceeds e.g. over a current loop or a data bus according to the known standards (Profibus, Foundation, Fieldbus, CAN-Bus). The field devices are part of a manufacturing facility, whose management is very expensive. Information on the manufacturing facility, including its components, such as field devices, accumulates starting from the first day of planning. This information essentially concerns design, layout, procurement, installation, start-up, operation and maintenance, i.e. the total life cycle.

Maintaining and managing are significant cost factors of a manufacturing facility. The information needed for an optimum maintaining and managing of a manufacturing facility is located, as a rule, in various organizational units within a company or even in different companies. Each organizational unit or company has its own manner and way of keeping and maintaining data, which usually involves different computer systems or at least different application programs. For these reasons, information from the planning stages, for instance, is not, or only expensively, available for maintenance jobs.

Personnel in the involved organizational units only know the application programs used in their own units, and can not get even simple information from application programs with which they are not acquainted.

Object of the invention is to provide a method for maintaining and managing a manufacturing facility that avoids the above mentioned problems, that, in particular, enables an easy access to, and care for, all data of a manufacturing facility.

The object is solved by a method for maintaining and managing a manufacturing facility, as such method is defined in claim 1.

Advantageous further developments of the invention are set forth in the dependent claims.

The invention is explained below in further detail on the basis of an example of an embodiment illustrated in the drawings, which show as follows:

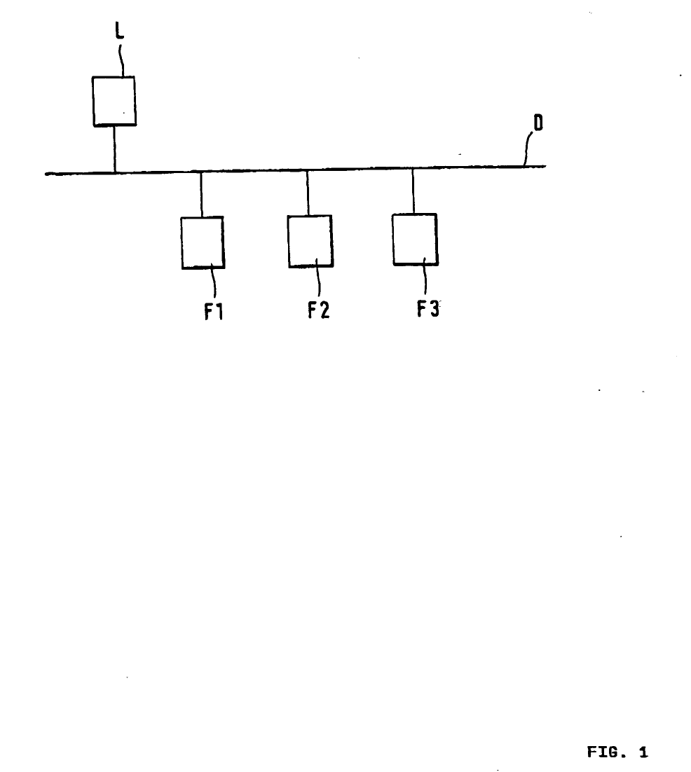

FIG. 1—Manufacturing facility with several field devices;

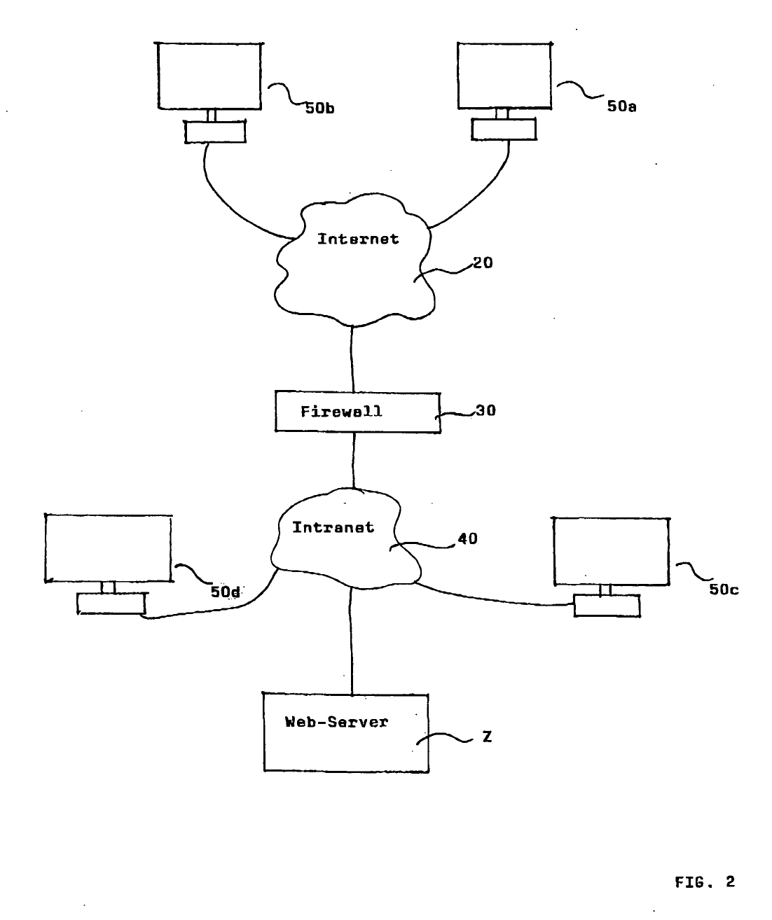

FIG. 2—Central database with Internet access.

The manufacturing facility of FIG. 1 includes a guide system L, which is connected over a data bus D with a plurality of field devices F1, F2 and F3. These field devices F1 to F3 can be, for example, pressure measurers, temperature measurers or flow measurers. The guide system L communicates over a data bus with each field device, e.g. F1. In this way, data can be transmitted between the field device F1 and the guide system L. The data communication over the field bus proceeds according to the corresponding international standards, such as, for example, Profibus, Foundation, Fieldbus (FF) or CAN-Bus. The field devices are arranged at the involved components of the manufacturing facility, for instance, tank, pipeline, etc. The drawing shows a manufacturing facility with only three field devices. Larger manufacturing facilities can exhibit far more than 1000 field devices.

The labeled box for guide system L is understood to include connection to an umbrella, company communication network, which normally also exhibits an Internet access.

FIG. 2 shows a plurality of computer units 50a, 50b, 50c, 50d, which are connected with the Internet 20 or with the intranet 40. A firewall 30 is placed between intranet 40 and Internet 20. A central database Z is likewise connected with the intranet 40.

The computer units 50a, 50b can be located in different companies. The computer units 50c, 50d connected to the intranet 40 are located within one company. The central database Z can be located, for example, at the manufacturer of the field devices.

The two priority documents are incorporated here by reference in their entireties.

The method of the invention will now be explainer in greater detail.

All information concerning the maintaining and managing of the manufacturing facility, especially information on field devices F1, F2, F3, is electronically registered and stored in the central database Z. Such information arises in the design, layout, procurement, installation and startup, as well as during operation and in maintenance activities, i.e. over the entire life cycle of the field devices.

Every affected person or thing in these areas can place its information into the central database Z by means of special application programs in one of the computer units, for example 50a, 50b, 50c, 50d, or extract information out of this central database Z, as the case may be. Users access the database Z over the Internet or intranet using standard browsers (Explorer, Netscape Navigator). Open data formats are used for the integration of all field devices.

In this way, all necessary information over the entire life cycle of a field device is available via Internet or intranet to selected users for queries on maintaining and managing the manufacturing facility.

Unique identification of the individual field devices in the database Z is accomplished using an instrument identification number. The instrument identification number can simultaneously serve as IP-address for the corresponding field device.

In order to prevent unauthorized access to the central database Z, every authorized user receives a password,

Especially ordering data, design data, installation information, startup information, operational information, and maintenance information are stored in the central database Z for the field devices.

With the method of the invention, all necessary information for maintaining and managing the manufacturing facility is available to selected users in simple manner over the web.

1. Method for maintaining and managing a manufacturing facility having a plurality of field devices connected by way of a data bus with a guide system, comprising the steps of:
a) electronically registering information for at least those field devices, which are required for maintaining and managing the manufacturing facility, over the entire life cycle of each field device;
b) storing this information via intranet or Internet access in a central database that is accessible for selected users;
c) querying the central database Z by the user using maintaining or managing criteria via intranet or Internet.

2. Method as claimed in claim 1, characterized in that each field device has for unique identification an instrument identification, which serves as key in the central database Z.

3. Method as claimed in one of the preceding claims, characterized in that access to the central database Z is password protected.

4. Method as claimed in one of the preceding claims, characterized in that ordering data of the field devices is stored in the central database Z.

5. Method as claimed in one of the preceding claims, characterized in that design data of the field devices is stored in the central database Z.

6. Method as claimed in one of the preceding claims, characterized in that installation information of the field devices is stored in the central database Z.

7. Method as claimed in one of the preceding claims, characterized in that startup information of the field devices is stored in the central database Z.

8. Method as claimed in one of the preceding claims, characterized in that operating information of the field devices is stored in the central database Z.

9. Method as claimed in one of the preceding claims, characterized in that maintenance information of the field devices is stored in the central database Z.
